(19) United States
(12) Patent Application Publication
(10) Pub. No.: US 2006/0095922 A1
(43) Pub. Date: May 4, 2006

(54) Response Time to Process Desired Transaction Requests in Event Based Network Servers

(75) Inventor: Feroz Alam KHAN, Bangalore (IN)

Correspondence Address: LAW FIRM OF NAREN THAPPETA, C/O LANDON IP, INC., 1700 DIAGONAL ROAD, SUITE 450, ALEXANDRIA, VA, 22314, US

(73) Assignee: ORACLE INTERNATIONAL CORPORATION, Redwood Shores (US)

(21) Appl. No.: 10/904,290

(22) Filed: Nov. 3, 2004

(51) Int. Cl. G06F 7/00

(52) U.S. Cl. 719/318

(57) ABSTRACT

Improving response time to process desired transaction requests in event based network servers, which execute in a single process. The response time is improved by processing the desired transaction requests ahead of other prior arriving transaction requests. In one embodiment, such desired transaction requests are determined based on connections on which the transaction requests are received. Arrival of transaction requests on high priority connections causes the signal handler to be executed on a preemptive basis, and the signal handler causes the transaction requests received on the high priority connections to be executed.

### BACKGROUND OF THE INVENTION

1. Field of the Invention

The present invention relates to network servers, and more specifically to a method and apparatus to improve the response time to process desired transaction requests in event based network servers.

2. Related Art

Network servers are often employed to process various transaction requests. In general, a network server receives a transaction request from a client over a network, processes the transaction request, and sends a response to the client on the network. A network server may access various other systems (e.g., database servers) while processing the transaction request.

Network servers are implemented using various approaches, one of which is based on event based models. An event based network server (hereafter “network servers” for simplicity) generally processes many transaction requests (on several connections) in a single thread or process (together referred to as a process for conciseness). By using such a single process, the overhead of creating processes is avoided, thereby making available the processing and memory resources available for processing transaction requests received on a network.

However, one problem with such network servers is that the transaction requests may be processed strictly according to order of arrival. At least in situations when bursts of transaction requests are received, some of the transaction requests may not receive their turn to be processed in a desired duration. For example, there can be critical transaction requests (or any desired transaction requests, in general) which need to be processed more quickly than other transaction requests.

Accordingly, what is needed is a method and apparatus a method and apparatus to improve the response time to process desired transaction requests in event based network servers.

### BRIEF DESCRIPTION OF THE DRAWINGS

The present invention will be described with reference to the accompanying drawings briefly described below.

FIG. (FIG.) 1 is a block diagram illustrating the details of an example environment in which various aspects of the present invention can be implemented.

FIGS. 2A and 2B together contain an example pseudo-code illustrating the manner in which various aspects of the present invention are implemented in one embodiment.

FIGS. 3A and 3B together contain another example pseudo-code illustrating the manner in which various aspects of the present invention are implemented in an alternative embodiment.

FIG. 4 is a block diagram illustrating an example embodiment in which various aspects of the present invention are operative when software instructions are executed.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

An event based network server provided according to an aspect of the present invention processes a first set of transaction requests ahead of a second set of transaction requests, even if the second set of transaction requests are received ahead of the first set of transaction requests. Due to such ability to process transaction requests in an order different from the order of arrival, the response time to process the first set of transaction requests may be reduced in event based network servers.

Another aspect of the present invention preempts the processing of lower priority transaction requests when higher priority transaction requests arrive. Due to such pre-emptive processing, the higher priority transaction requests may be processed quickly.

In one embodiment, both the above aspects are attained by assigning the first set of transaction requests to a signal handler (or a handler of a software interrupt) which is provided pre-emptive priority over another routine which handles the second set of transaction requests. As signal handlers are often supported in event based network servers, such an approach enables various aspects of the present invention to be widely used in event based network servers.

In one embodiment described below, the first set of transaction requests are determined by the connections on which the transaction requests arrive, and accordingly all transaction requests received on such connections are processed in the signal handler. In addition, the assignment of connections to the signal handler is performed in the same routine as that in which the lower priority transaction requests are processed. As a result, the first set of transaction requests received on the connections are serviced in a shorter time duration.

Various aspects of the present invention are described below with reference to an example problem. Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well_known structures or operations are not shown in detail to avoid obscuring the invention.

2. Example Environment

FIG. 1 is a block diagram illustrating an example environment in which various aspects of the present invention can be implemented. The environment is shown containing client systems 110-1 through 110-N, networks 120 and 130, event based network server 150, and database server 170. Each system/device is described below in further detail.

Client systems 110-1 through 110-N send transaction requests to event based network server 150 and receive the corresponding responses. Network 120 may be used to send and receive such responses. Network 120, as well network 130, may be implemented using protocols such as Internet Protocol. Even though shown as different networks, networks 120 and 130 may be integrated into a single network.

Event based network server 150 processes the transaction requests received from client systems 110-A through 110-N, and sends the corresponding responses as a part of such processing. To process the transaction requests, event based network server 150 may access external systems such as data base server 170 using network 130. Event based network server 150 may be implemented on servers available from vendors such as Sun Microsystems, Microsoft, IBM, etc., implementing Unix-type operating systems (in general, event based servers).

Event based network server 150 processes some (desired) transaction requests ahead of some other earlier received transaction requests. As a result, the desired transaction requests may be processed quickly. The manner in which such out-of-sequence processing may be performed is described below with respect to various examples.

3. Processing Transaction Requests Quickly

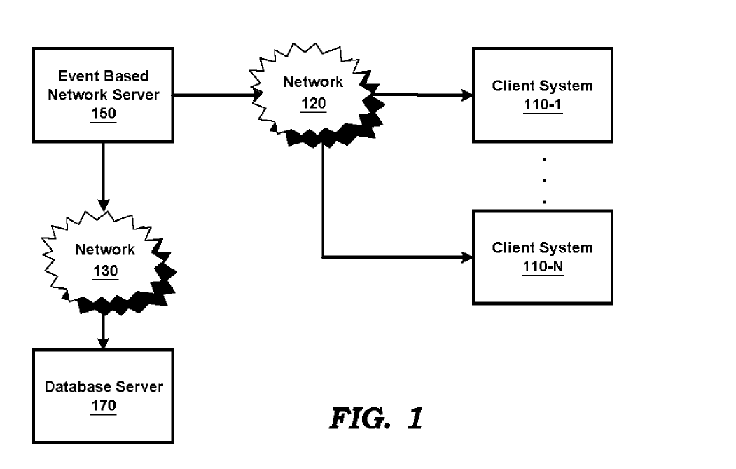

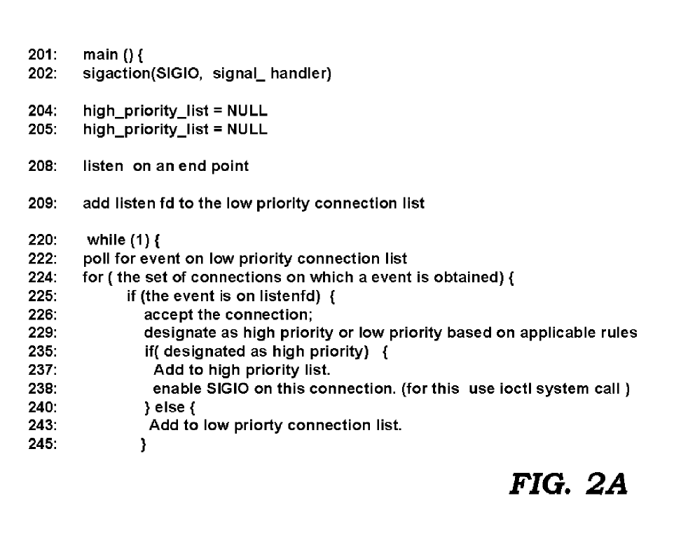

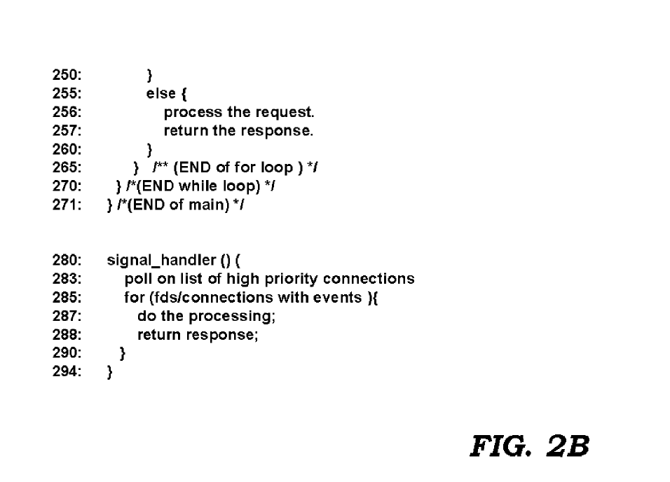

In one embodiment, the transaction requests sought to be provided high priority are assigned to a signal handler which is provided pre-emptive priority, and such assigned transaction requests are executed quickly due to the pre-emptive priority. Signal handlers are described in a book entitled, “Unix network programming: Volume 1 (Second Edition)”, by Richard Steven, ISBN Number:. The corresponding psuedo-code is described below with reference to FIGS. 2A and 2B.

Execution of the sigaction function call in line 202 causes the routine signal_handler to be called when SIGIO occurs. The business logic for signal_handler is described below with reference to lines 280-294. In lines 204 and 205, lists for high priority and low priority connections are initialized to null value.

In line 208, instructions are included to listen on an end point. In the TCP/UDP/IP environment, the end point is generally pre-specified as a destination port number for a specific IP protocol (UDP or TCP). When client system 110-1 establishes a connection, the corresponding packet is received due to the listen operation.

In line 209, the listen file description (fd) (on which requests for new connections are received) is added to the low priority connection list. Due to such addition, the requests for connections are processed along with the low priority transaction requests in a single routine, as described below in further detail with reference to the while loop of lines 220-270.

In line 222, an event is polled (e.g., poll( ) or select( ) calls in Unix Environments) for on the low priority connection list. The polling is a blocking call, i.e., within the context of the routine in which line 222 is executed, execution does not move to the next line. The call unblocks as soon as there is at least one event is present in the low priority connection list. The loop of lines 225-265 processes each of the events.

Line 225 checks whether a present event (being processed in the present iteration of the loop) is received on listenfd (i.e., on which requests for connections are received). Lines 226-250 are executed if the present event is received on listen fd, and lines 255-260 otherwise.

Line 226 accepts the connection. Accepting generally entails tasks such as authentication, creating the appropriate data structures in the memory so that subsequent transaction requests can be associated with the connection.

Line 229 designate the connection as either low priority or high priority. The determination of priority can be based on various approaches. For example, the IP source address can be used to determine the priority. Alternatively, more complex mechanisms may be established (e.g., based on negotiation with the client system) to designate a connection as of low or high priority. Lines 237-238 are executed if the connection is of high priority, and line 243 otherwise.

Line 237 adds the connection to the high priority list and line 238 enables SIGIO on this connection. As a result, when an event is received on high priority connections, the signal_handler routine of line 280 is invoked pre-empting the while loop. In one embodiment, the addition is performed using a system call ioctl (newsockfd, I_SETSIG, S_INPUT), wherein S_INPUT indicates that SIGIO is to be generated whenever new data arrives for this fd (assuming newsockfd represents the file descriptor of the connection sought to be added to the high priority list).

Line 243 adds the connection to the low priority list. As a result, low priority transaction requests are processed within the context of the while loop, as described below in further detail.

Line 256 processes the transaction request, and any desired business logic may be implemented in lieu of line 256. Line 257 returns the response. Thus, the transaction requests received on low priority connections are processed in lines 256 and 257.

Lines 280-294 forming the body of the code for signal_handler process the transaction requests received on high priority list of connections. Line 283 polls the connections on the high priority list. The for loop of lines 285-290 processes each of the events received on all the high priority connections together.

It may be appreciated that the the software interrupts provide pre-emptive priority to a process executing signal_handler routine, and thus the transaction requests received on the high priority list are processed quickly.

While the approach is described above with reference to only two levels of priority, it should be appreciated that multiple levels of priorities can be implemented without departing from the scope and spirit of various aspects of the present, as will be apparent to one skilled in the relevant arts by reading the disclosure provided herein.

One potential problem with the approach of FIGS. 2A and 2B is that some operating systems do not permit some of the library calls containing system calls to be executed in interrupt handlers (i.e., in signal_handler). Since any library call can be replaced by software instructions, applications can be implemented without library calls. An alternative approach to such a problem is described below.

4. Alternative Approach

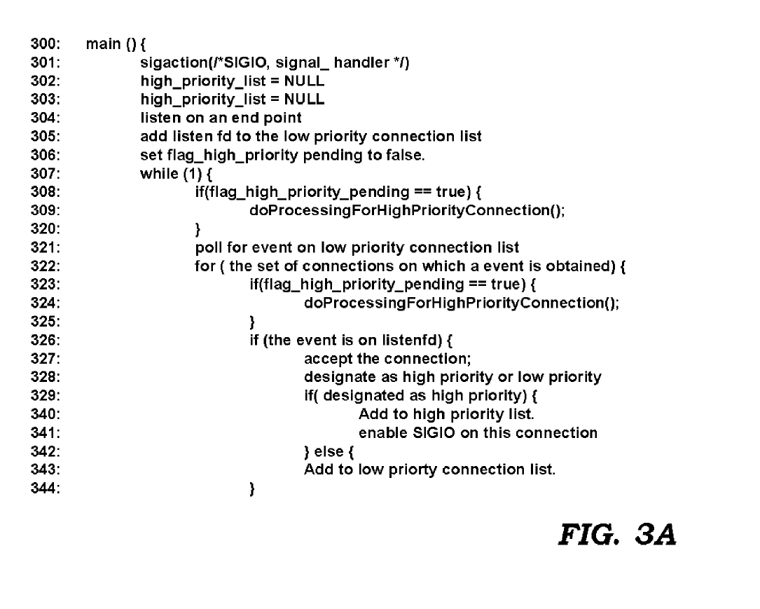

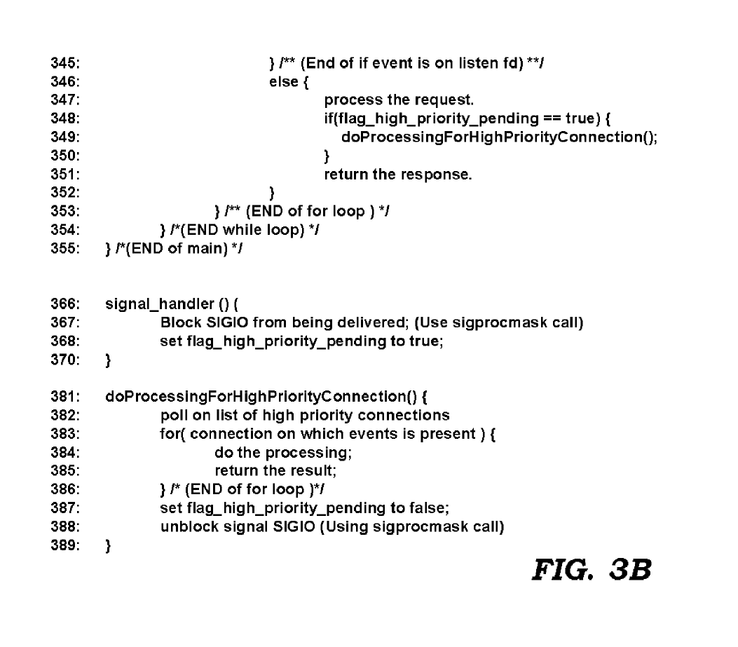

The pseudo code representing the alterative approach is contained in FIGS. 3A and 3B. The alternative approach is described in comparison to FIGS. 2A and 2B, merely for conciseness.

Broadly, in the alternative approach, a flag flag_high_priority_pending is set to true in the signal handler (and interrupts blocked). In the main program, in the while loop, the status of the flag is checked at various points (only a few times shown in FIGS. 3A and 3B, for illustration), and a procedure doProcessingForHighPriorityConnection( ) is executed to process the transaction requests received on the high priority connections. The pseudo-code of FIGS. 3A and 3B is described below in further detail.

Lines 301-305 operate similar to lines 202-209 of FIG. 2A, and the description is not repeated in the interest of conciseness. Line 306 sets the flag_high_priority pending to false before entering the while loop of lines 307-354.

Lines 308-320 executes doProcessingForHighPriorityConnection( ) if flag_high_priority pending is at True state. Lines 308-320 are advantageously placed in the beginning of the while loop. Similarly, lines 323-325, performing similar operation, are placed at the beginning of for loop 322-353. Lines 348-350 represents another instance where similar operation is sought to be performed.

The remaining portions of the while loop 307-354 operates similar to the corresponding portions of FIGS. 2A and 2B, as briefly noted now. Lines 321-322, 326-347, and 257 of FIG. 3A respectively substantially parallel lines 222-224, 225-256, and 257 of FIG. 2A.

Signal_handler( ) of lines 366-370 blocks the interrupt (SIGIO) from being delivered, for example, using sigprocmask call (which is generally used to enable or disable delivery of signals) available in the Unix environments. As noted the SIGIO delivery is unblocked once all the pending transaction requests on the high priority connections are processed.

Procedure doProcessingForHighPriorityConnection( ) of lines 381-389 processes the pending high priority transaction requests (similar to in lines 283-290 lines of FIG. 2B), sets the flag_high_priority_pending flag to false (in line 387), and unblocks SIGIO (line 388). Setting the flag to false enables the transactions on the lower priority connections to be processed. Unblocking SIGIO enables software interrupts to be received again.

Thus, transaction requests of high priority can be processed without having to use library calls (using system calls) in signal handlers. The description is continued with respect to an embodiment in which various aspects of the present invention are operative by execution of software instructions.

5. Digital Processing System

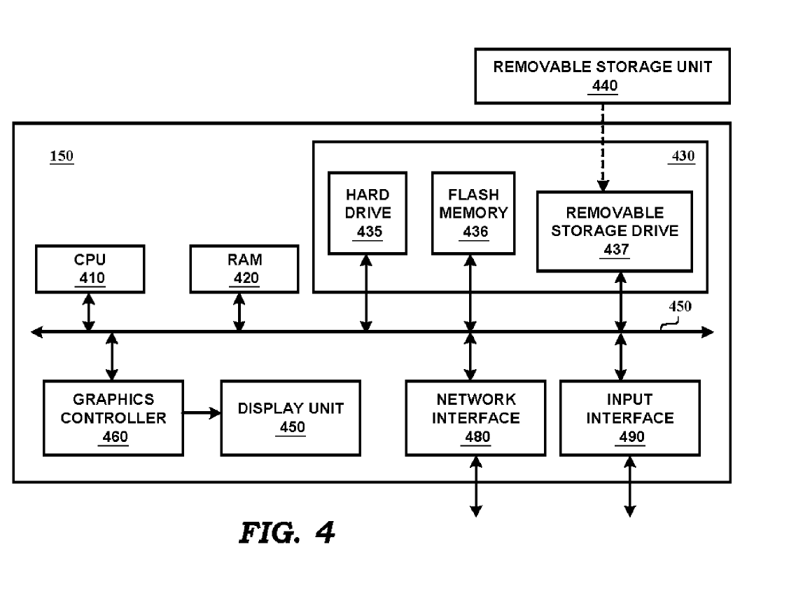

FIG. 4 is a block diagram illustrating the details of event based server 150 in which various aspects of the present invention are operative by execution of appropriate software instructions. Server 150 may contain one or more processors such as central processing unit (CPU) 410, random access memory (RAM) 420, secondary memory 430, graphics controller 460, display unit 470, network interface 480, and input interface 490. All the components except display unit 470 may communicate with each other over communication path 450, which may contain several buses as is well known in the relevant arts. The components of FIG. 4 are described below in further detail.

CPU 410 may execute instructions stored in RAM 420 to provide several features of the present invention. CPU 410 may contain multiple processing units, with each processing unit potentially being designed for a specific task. Alternatively, CPU 410 may contain only a single general purpose processing unit. RAM 420 may receive instructions from secondary memory 430 using communication path 450.

Graphics controller 460 generates display signals (e.g., in RGB format) to display unit 470 based on data/instructions received from CPU 410. Display unit 470 contains a display screen to display the images defined by the display signals. Input interface 490 may correspond to a key_board and/or mouse. Network interface 480 provides connectivity to a network (e.g., using Internet Protocol), and may be used to receive various transaction requests and provide the corresponding responses.

Secondary memory 430 may contain hard drive 435, flash memory 436 and removable storage drive 437. Secondary memory 430 may store the data and software instructions (e.g., methods instantiated by each of client system), which enable server 150 to provide several features in accordance with the present invention. Some or all of the data and instructions may be provided on removable storage unit 440, and the data and instructions may be read and provided by removable storage drive 437 to CPU 410. Floppy drive, magnetic tape drive, CD_ROM drive, DVD Drive, Flash memory, removable memory chip (PCMCIA Card, EPROM) are examples of such removable storage drive 437.

Removable storage unit 440 may be implemented using medium and storage format

compatible with removable storage drive 437 such that removable storage drive 437 can read

the data and instructions. Thus, removable storage unit 440 includes a computer readable storage medium having stored therein computer software and/or data.

In this document, the term “computer program product” is used to generally refer to

removable storage unit 440 or hard disk installed in hard drive 435. These computer program products are means for providing software to server 150. CPU 410 may retrieve the software instructions, and execute the instructions to provide various features of the present invention described above.

6. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of improving response time to process desired transaction requests in an event based network server which processes transactions in a single process, said method comprising:
receiving in said event based network server a first set of transaction requests and then receiving a second transaction request; and
starting processing said first set of transaction requests;
preempting processing of said first set of transaction requests upon receiving said second transaction request; and
completing processing said second transaction request and then said first set of transaction requests,
wherein said second transaction request is comprised in said desired transaction requests.

2. The method of claim 1, further comprising generating a software interrupt upon arrival of said second transaction request in said event based network server, wherein a handler of said software interrupt causes said second transaction request to be processed.

3. The method of claim 2, wherein said software interrupt comprises SIGIO.

4. The method of claim 2, wherein said first set of transaction requests are received on a first connection and said second transaction request is received on a second connection, said method further comprising:
enabling said software interrupt on said second connection, but not said first connection.

5. The method of claim 4, wherein said processing is performed in said handler.

6. The method of claim 4, wherein said handler sets a flag to a first state indicating that said software interrupt has occured, and wherein a procedure is executed to process said second transaction request if said flag is at said first state, said procedure further setting said flag to a second state after completing processing said second transaction request.

7. A method of improving response time to process desired transaction requests in an event based network server which processes transactions in a single process, said method comprising:
receiving in said event based network server a first transaction request and then receiving a second transaction request; and
processing first said second transaction request and then said first transaction request,
wherein said second transaction request is comprised in said desired transaction requests.

8. The method of claim 7, further comprising generating a software interrupt upon arrival of said second transaction request in said event based network server, wherein a handler of said software interrupt causes said second transaction request to be processed.

9. The method of claim 8, wherein said first transaction request is received on a first connection and said second transaction request is received on a second connection, said method further comprising:
enabling said software interrupt on said second connection, but not said first connection.

10. The method of claim 9, wherein said processing is performed in said handler.

11. The method of claim 9, wherein said handler sets a flag to a first state indicating that said software interrupt has occurred, and wherein a procedure is executed to process said second transaction request if said flag is at said first state, said procedure further setting said flag to a second state after completing processing said second transaction request.

12. A computer readable medium carrying one or more sequences of instructions causing a digital processing system to improve response time to process desired transaction requests in an event based network server which processes transactions in a single process, wherein execution of said one or more sequences of instructions by one or more processors contained in said digital processing system causes said one or more processors to perform the actions of:
receiving in said event based network server a first set of transaction requests and then receiving a second transaction request; and
starting processing said first set of transaction requests;
preempting processing of said first set of transaction requests upon receiving said second transaction request; and
completing processing said second transaction request and then said first set of transaction requests,
wherein said second transaction request is comprised in said desired transaction requests.

13. The computer readable medium of claim 12, further comprising generating a software interrupt upon arrival of said second transaction request in said event based network server, wherein a handler of said software interrupt causes said second transaction request to be processed.

14. The computer readable medium of claim 13, wherein said software interrupt comprises SIGIO.

15. The computer readable medium of claim 13, wherein said first set of transaction requests are received on a first connection and said second transaction request is received on a second connection, further comprising:
enabling said software interrupt on said second connection, but not said first connection.

16. The computer readable medium of claim 15, wherein said processing is performed in said handler.

17. The computer readable medium of claim 15, wherein said handler sets a flag to a first state indicating that said software interrupt has occurred, and wherein a procedure is executed to process said second transaction request if said flag is at said first state, said procedure further setting said flag to a second state after completing processing said second transaction request.

18. A computer readable medium carrying one or more sequences of instructions causing a digital processing system to improve response time to process desired transaction requests in an event based network server which processes transactions in a single process, wherein execution of said one or more sequences of instructions by one or more processors contained in said digital processing system causes said one or more processors to perform the actions of:
receiving in said event based network server a first transaction request and then receiving a second transaction request; and
processing first said second transaction request and then said first transaction request,
wherein said second transaction request is comprised in said desired transaction requests.

19. The computer readable medium of claim 18, further comprising generating a software interrupt upon arrival of said second transaction request in said event based network server, wherein a handler of said software interrupt causes said second transaction request to be processed.

20. The computer readable medium of claim 19, wherein said first transaction request is received on a first connection and said second transaction request is received on a second connection, further comprising:
enabling said software interrupt on said second connection, but not said first connection.

21. The computer readable medium of claim 20, wherein said processing is performed in said handler.

22. The computer readable medium of claim 20, wherein said handler sets a flag to a first state indicating that said software interrupt has occurred, and wherein a procedure is executed to process said second transaction request if said flag is at said first state, said procedure further setting said flag to a second state after completing processing said second transaction request.
